(19) United States
(12) Patent Application Publication
(10) Pub. No.: US 2023/0245057 A1
(43) Pub. Date: Aug. 3, 2023

(54) Procurement Category Management System and Method

(71) Applicant: Anders Lillevik, Brookhaven, GA (US)

(72) Inventor: Anders Lillevik, Brookhaven, GA (US)

(21) Appl. No.: 18/009,866

(22) PCT Filed: Apr. 12, 2021
(86) PCT No.: PCT/US21/26894

§ 371 Date: Dec. 12, 2022

Related U.S. Application Data
(60) Provisional application No. 63/008,243, filed on Apr. 10, 2020.

(51) Int. Cl. G06Q 10/087

(52) U.S. Cl. CPC G06Q 10/087

(57) ABSTRACT

A system and method for procurement category management is provided. Generally, data is gathered from a number of data sources, including existing data from external sources and input data gathered directly from the user. A database of categories is formed, where each category corresponds to the gathered data corresponding to each procurement category. For each category, parameters are determined that are indicative of criticality, risk and strategic value. These parameters are analyzed to determine a category strategy for each category in the database of categories. Each category may include a number of projects defined in a project list. Furthermore, the category strategy may be modified manually or automatically as data changes are identified. Additionally, category metrics can be utilized to determine the effectiveness of each strategy.

### CROSS REFERENCE TO RELATED APPLICATIONS

This application claims the benefit of U.S. Provisional Application No. 63/008,243 filed on Apr. 10, 2020. The above identified patent application is herein incorporated by reference in its entirety to provide continuity of disclosure.

### BACKGROUND OF THE INVENTION

The present invention relates to a system and method for managing product expense. More specifically, the present invention provides a mechanism through which a user may view information he or she needs to assess opportunities and risks for a number of different spending categories.

Many companies have procurement specialists or procurement departments that are charged with obtaining necessary supplies and resources for that company to function. In the course of operations for procurement specialists, items are grouped into categories to assist in identifying relevant data. Most of this classification is done manually, requiring a large amount of time spent on data input. This amount of time is often disproportionate to the amount of time spent on analysis. Because of the time constraints and effort put into data input, this work is commonly done poorly or not at all.

Because of the long-felt need to input and monitor data across several different categories, many software suites have attempted to provide various functionalities to businesses in monitoring their expenses. However, even as these systems have developed, most companies are still using an array of different programs and applications to manage a variety of different categories. In addition to requiring the procurement specialists or department to devote a significant amount of time to data classification, input and management, the personnel also need to be proficient in working across several platforms. In addition to being laborious, using multiple programs and applications increases the risk and effects of misclassification or non-classification.

Current solutions also lack the convenience of having a single interface for all procurement strategies and solutions and interferes with the organizational capability to make informed decisions. Modern suite providers generally only provide sufficient integration to execute the specific functions of that suite. As previously stated, when all of an organization's procurement data is spread out between various programs or is simply unrecorded, the procurement personnel are left doing tactical work as opposed to being value-adding stakeholders in the organization.

Therefore, there is a defined need amongst the known prior art references for a procurement management system that allows for a simple and effective process of classifying, managing and analyzing an organization's entire portfolio of procurement data. Such a comprehensive solution will allow for procurement personnel to access data that will enable better decision-making and ultimately better financial results.

### SUMMARY OF THE INVENTION

In view of the foregoing disadvantages inherent in the known types of procurement data consolidation and analyzation methods and processes now present in the prior art, the present invention provides a system wherein the same can be utilized for providing convenience for the user when consolidating and analyzing procurement data while.

The initial step in the process is data consolidation. Since procurement data is generally spread out amongst a number of disparate sources, relevant data may be gathered manually through the use of input forms or may be gathered automatically from existing sources or alternate programs. Once the relevant data is gathered, the data undergoes classification. Classification may be done at one or more levels of specificity, such as to define a number of categories, wherein each category may comprise one or more subcategories. Once the data is consolidated, a category spend map may be generated.

Once an amount of data is consolidated, a strategy may be personalized. For the number of categories defined during data consolidation, category dimensions may be defined. Additionally, the competitive state of the category can be determined. The internal landscape may be mapped. The user is further able to set priorities to personalize the strategy developed using the procurement strategy management system. Once the strategy parameters are defined, internal stakeholders will be able to collaborate amongst themselves to finalize the strategy. In doing so, the internal stakeholders will be able to set priorities, develop projects and assign owners.

Each project developed may be mapped. The system will allow for high priority projects to be identified. Users will then be able to set completions times, benchmarks for benefits and other relevant information. Using a dynamic dashboard, the users will be able to follow the progress of any number of defined projects. The dashboard may also provide any other relevant information, such as any key market factors.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagrammatic view of an exemplary host system for use in the procurement category management system.

FIG. 2 shows a diagrammatic view of an exemplary embodiment of the procurement category management system.

FIG. 3 shows a flow chart of the process performed in an exemplary embodiment of the procurement category management system.

FIG. 4A shows a dashboard of an exemplary embodiment of the procurement category management system.

FIG. 4B shows a subcategory dashboard of an exemplary embodiment of the procurement category management system.

FIG. 5A shows a demonstrative view of an embodiment of the procurement category management system.

FIG. 5B shows a demonstrative view of an embodiment of the procurement category management system.

FIG. 5C shows a demonstrative view of an embodiment of the procurement category management system.

FIG. 5D shows a demonstrative view of an embodiment of the procurement category management system.

FIG. 5E shows a demonstrative view of an embodiment of the procurement category management system.

FIG. 5F shows a demonstrative view of an embodiment of the procurement category management system.

FIG. 5G shows a demonstrative view of an embodiment of the procurement category management system.

FIG. 6A shows a demonstrative view of an embodiment of the procurement category management system.

FIG. 6B shows a demonstrative view of an embodiment of the procurement category management system.

FIG. 6C shows a demonstrative view of an embodiment of the procurement category management system.

FIG. 7A shows a demonstrative view of an embodiment of the procurement category management system.

FIG. 7B shows a demonstrative view of an embodiment of the procurement category management system.

FIG. 7C shows a demonstrative view of an embodiment of the procurement category management system.

FIG. 7D shows a demonstrative view of an embodiment of the procurement category management system.

FIG. 7E shows a demonstrative view of an embodiment of the procurement category management system.

FIG. 7F shows a demonstrative view of an embodiment of the procurement category management system.

FIG. 8 shows a demonstrative view of an embodiment of the procurement category management system.

### DETAILED DESCRIPTION OF THE INVENTION

Reference is made herein to the attached drawings. Like reference numerals are used throughout the drawings to depict like or similar elements of the procurement category management system. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

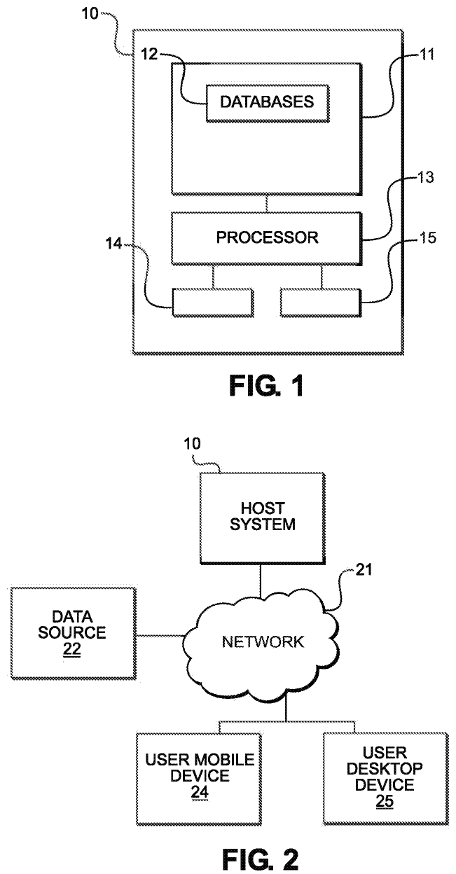

Referring now to FIG. 1, there is shown a diagrammatic view of an exemplary host system for use in the procurement category management system. The procurement category management system is implemented on a computer system 10. The computer system 10 comprises a computer-readable storage device 11. In one embodiment, the computer-readable storage device 11 is a cloud server. In another embodiment, the computer-readable storage device 11 is a local storage medium. In yet a further embodiment, other computer storage devices are utilized. The computer readable storage device 11 comprises a plurality of databases 12 thereon.

The procurement category management system further comprises a processor 13. The processor 13 is capable of reading computer instructions. Ideally, a processor 13 capable of machine learning processes or artificial intelligence processes will be utilized. In another embodiment, a plurality of processor cores may be utilized to create a more powerful processor 13.

Additionally, the procurement category management system further comprises an output device 14. The output device 14 can be a computer monitor. The output device 14 is configured to display a graphical user interface. The graphical user interface will provide a means by which the user can interact with the procurement category management system.

Furthermore, the procurement category management system further comprises one or more input devices 15. The one or more input devices 15 may be directly connected to the computer system 10 or may be connected wireless, such as via a network connection (demonstrated in FIG. 2). The one or more input devices 15 may comprise a touch screen, a keyboard, a mouse or any combination thereof.

Referring now to FIG. 2, there is shown a diagrammatic view of an exemplary embodiment of the procurement category management system. In the illustrated embodiment, the computer system 10 is in connection with a network 21. One or more data sources 22 may also be connected to the network 21, such that the computer system 10 may access the data sources 22 to create or modify the plurality of databases. Furthermore, a plurality of user devices 24, 25 may connect to the computer system 10 via the network 21. The plurality of user devices 24, 25 may comprise at least one user mobile device 24 and at least one user desktop device 25. The plurality of user devices 24, 25 may be utilized as both data sources or as output devices through which data may be viewed, input or managed.

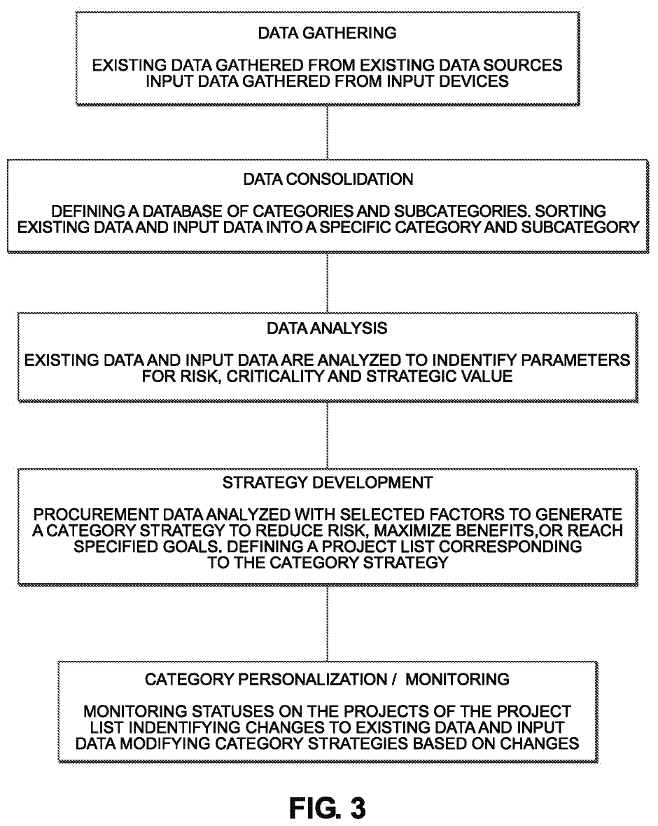

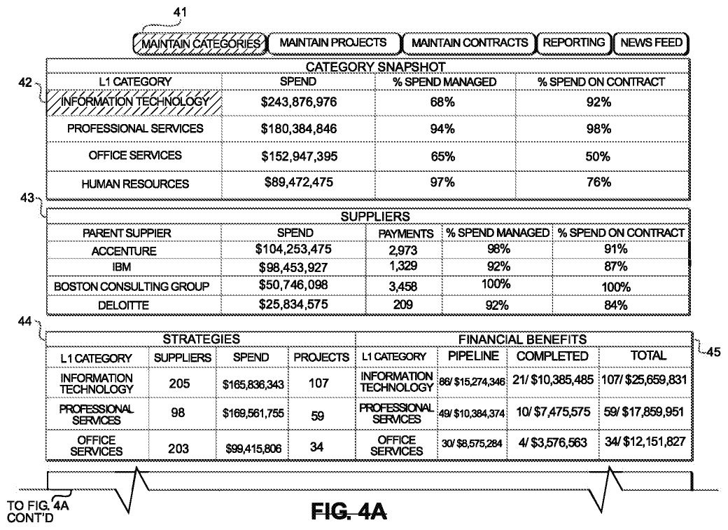

Referring now to FIG. 3, there is shown a flow chart of the process performed in an exemplary embodiment of the procurement category management system. The initial step in the process is data consolidation. Generally, data is gathered by the input devices connected to the computer system, as well as through any network sources. Since procurement data is generally spread out amongst a number of disparate sources, relevant data may be gathered manually through the use of input forms or may be gathered automatically from existing sources or alternate programs. Artificial intelligence may be utilized to gather data from any number of existing sources. The gathered data may include vendor information. Vendor information includes information about any company or individual that supplies a product or service to the user, as well as information about the products or services themselves. Specifically, this can include the prices, costs, amounts, contract values, contract lengths, payment information, and the like.

Once the relevant data is gathered, the data undergoes classification wherein a database of categories is created. Each category comprises a portion of the existing data and the input data that corresponds to the specific category. Classification may be done at one or more levels of specificity, such as to define a number of categories, wherein each category may comprise one or more subcategories. For example, a category associated with “Information Technology” may include subcategories such as “Application Software,” “Development Services,” “Infrastructure Services,” “Hardware,” “Maintenance,” “Network Services,” “Telephony,” and the like. Each subcategory may further include subcategories thereunder. For example, the “Hardware” subcategory may further include subcategories for “Server Hardware,” “Network Hardware,” “Desktop Hardware,” “Peripherals,” and the like. Once the data for a specific category is consolidated, the data may be presented by any suitable mechanism, such as a category spend map.

The existing data and the input data are translated into procurement data. The procurement data comprises at least one parameter indicative of criticality, at least one parameter indicative of risk and at least one parameter indicative of value. These values will be determined primarily based on input data gathered by the input devices. A plurality of prompts may be utilized via the graphical user interface to determine each parameter. The user will be able to input values for performance bargaining power, market effects, the amount spent in each category, and business need.

The procurement data is utilized to determine a category strategy for each category and sub-category of the database of categories. This strategy can be based on any number of selected factors. For example, a Porter Analysis may be utilized to determine industry competition factors. In light of the analyses, the category strategy will comprise risk assessments and recommendations for reducing identified risks. The category strategy will also comprise recommendations as to how benefits may be maximized for each category.

Each category strategy may be personalized. For the number of categories defined during data consolidation, category dimensions may be defined, Additionally, the competitive state of each category can be determined using input data and existing data. The internal landscape may be mapped, The user is further able to set priorities to personalize the strategy developed using the procurement strategy management system. Once the strategy parameters are defined, internal stakeholders will be able to collaborate amongst themselves to finalize the strategy. In doing so, the internal stakeholders will be able to set priorities, develop projects and assign owners to the projects.

A project list for each category may further be defined. Each project on the project list can be tracked and have a status defined. The effectiveness of each project on the project list may be determined using category metrics. The system will allow for high priority projects to be identified. Users will then be able to set completions times, benchmarks for benefits and other relevant information. Using a dynamic dashboard, the users will be able to follow the progress of any number of defined projects. The dashboard may also provide any other relevant information, such as any key market factors.

In some embodiments, changes to existing data and to input data may be monitored and identified. These changes may be analyzed, such that the category strategy may be modified based on these changes. As such, the procurement category management system may be utilized in real-time to identify any emerging issues that may otherwise be overlooked.

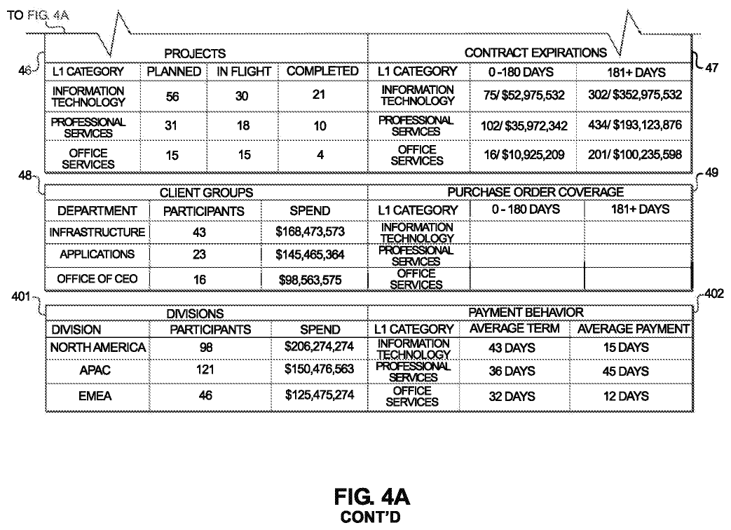

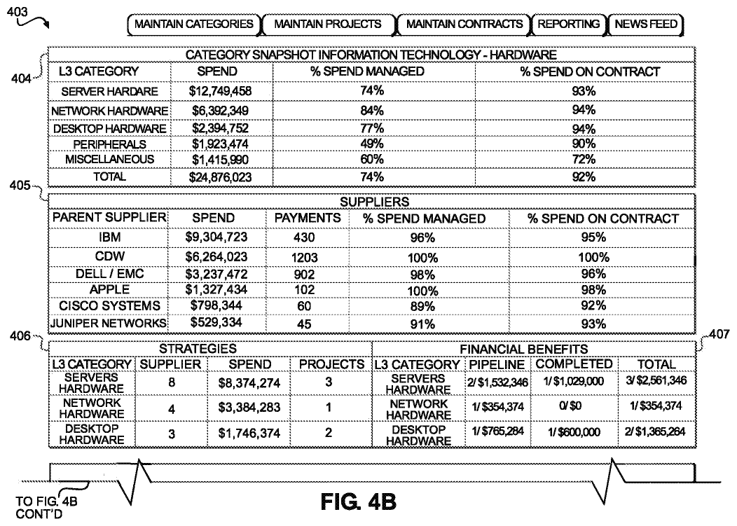

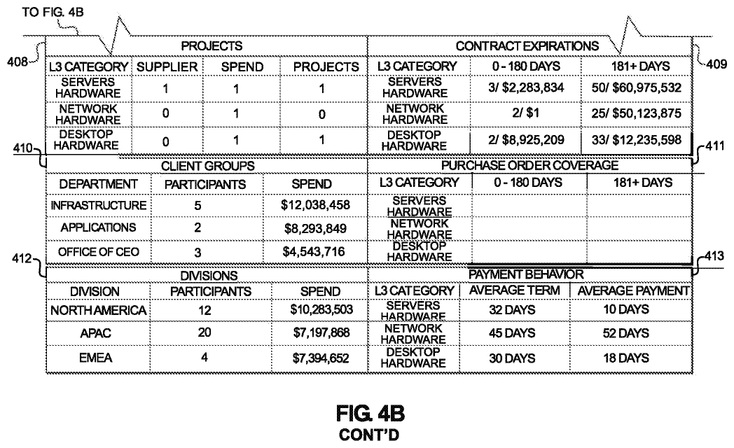

Referring now to FIG. 4A, there is shown a primary dashboard of an exemplary embodiment of the procurement category management system. The primary dashboard provides an interface for the user to observe and view data and analytics. In the demonstrated embodiment, the primary dashboard comprises a tool bar 41. The tool bar 41 comprises tabs for maintaining categories, maintaining projects, maintaining contracts, reporting and news feed. The user may define, add, remove or alter categories utilizing the maintain categories tab. The user may define, add, remove or alter projects utilizing the maintain projects tab. The user may define, add, remove or alter contracts utilizing the maintain contract tab.

Furthermore, the dashboard comprises a Category Snapshot interface 42. In the demonstrated embodiment, the Category Snapshot interface 42 shows the spending amount, percentage of spending managed and percentage of spending on contracts. As such, the user may be able to get an initial assessment of some spending characteristics of a specific category. Additionally, the primary dashboard, as shown, may further include a Suppliers interface 43. The Supplier interface 43, in the demonstrated embodiment, shows a spending amount for shown supplier, the number of payments made to the supplier, the percentage of the spending amount managed for the supplier and the percentage of the spending amount spent on contracts for the supplier.

Additionally, a number of other windows may be displayed on the dashboard. For example, in the shown embodiment, a Strategies interface 44 is provided showing a number of suppliers, spending a mount and number of projects for a number of categories. In the illustrated embodiment, a Financial Benefits interface 45, a Projects interface 46, a Contract Expirations interface 47, a Client Groups interface 48, a Purchase Order Coverage interface 49, a Divisions interface 401, and a Payment Behavior interface 402. Any number of interfaces reflecting desired datasets may be shown or displayed on the dashboard.

Referring now to FIG. 4B, there is shown a subcategory dashboard of an exemplary embodiment of the procurement category management system. In the illustrated embodiment, the sub-category dashboard 403 mirrors the primary dashboard, such that the user may view a Category Snapshot interface 404 for the selected sub-category. In the illustrated embodiment, the sub-category dashboard 403 further comprises a Suppliers interface 405, a Strategies interface 406, a Financial Benefits interface 407, a Projects interface 408, a Contract Expirations interface 409, a Client Groups interface 410, a Purchase Order Coverage interface 411, a Divisions interface 412 and a Payment Behavior interface 413.

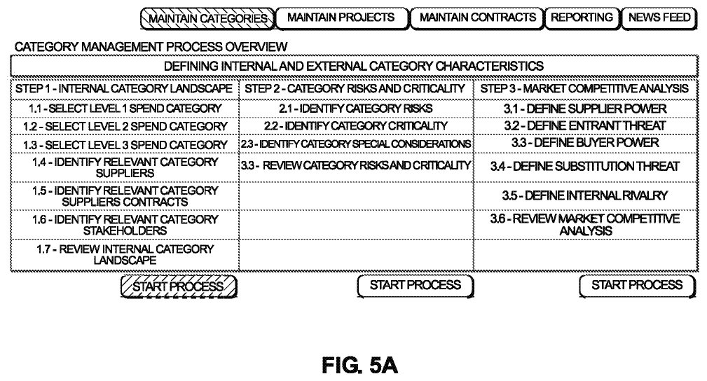

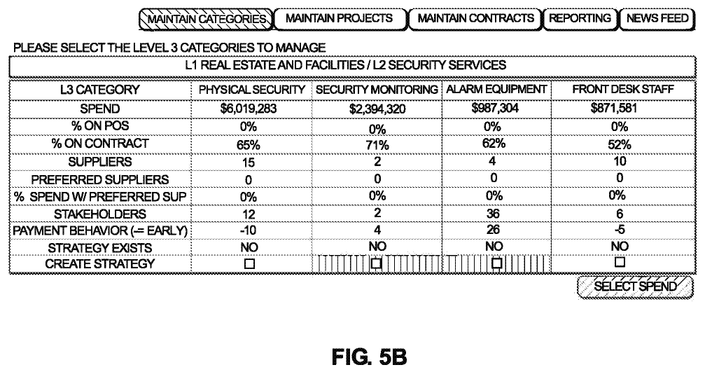

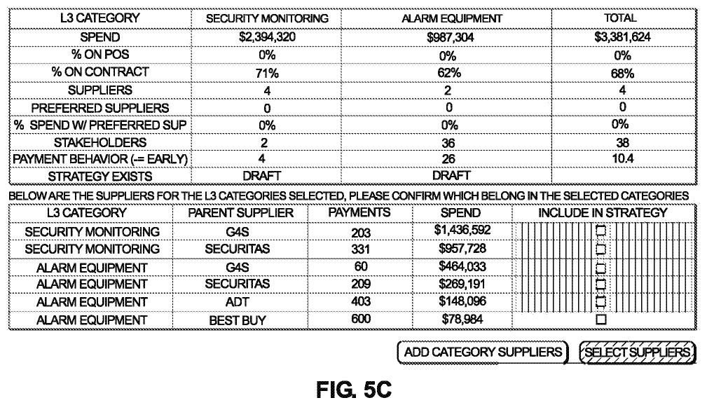

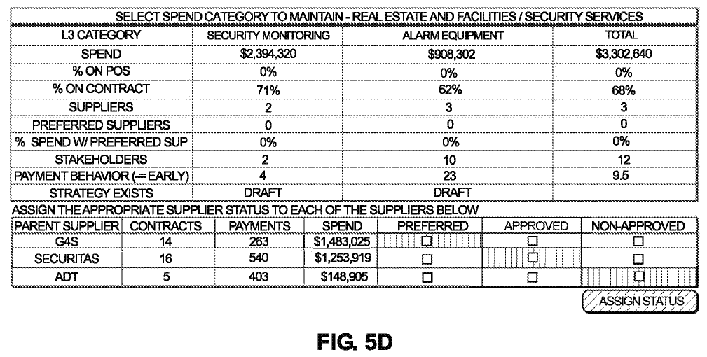

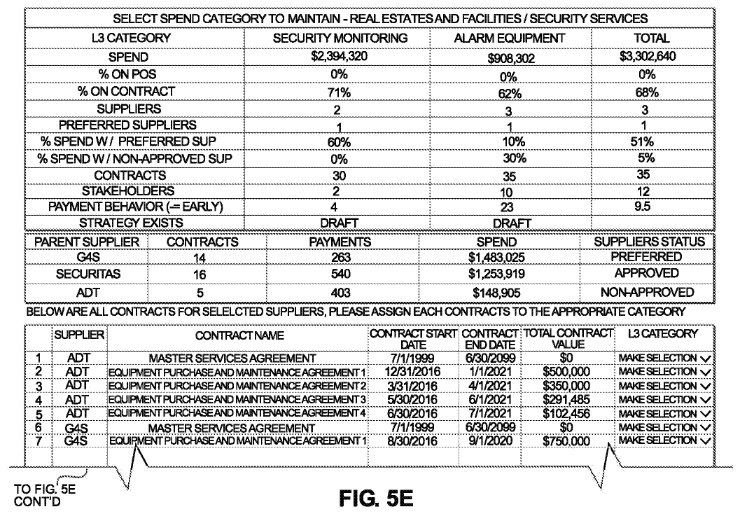

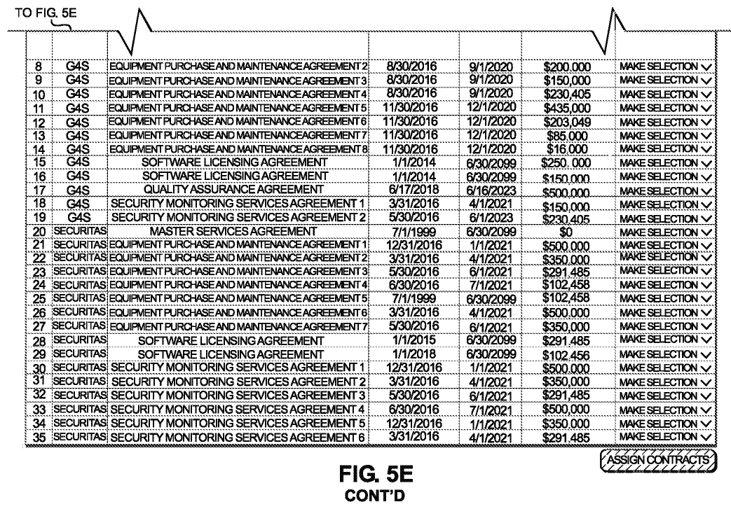

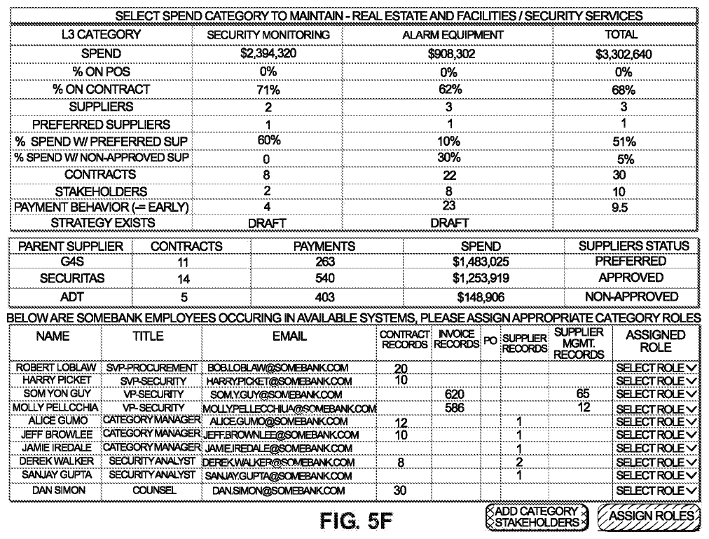

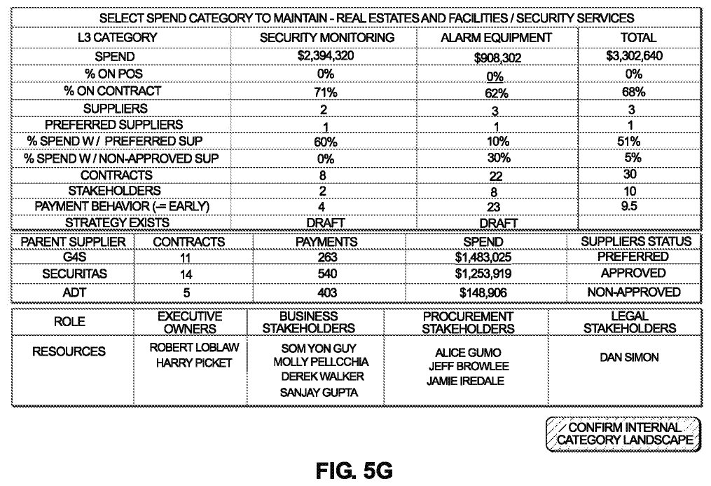

Referring now to FIGS. 5A-5G, there are shown demonstrative views of embodiments of the procurement category management system. The user will be able to utilize the dashboard to provide and manage Input Data. First, the user must define the Internal Category Landscape. This is done by first selecting the spend categories to manage, as shown in FIG. SB. Next, the user will identify the relevant suppliers by selecting which category suppliers to include in the category strategy (as shown in FIG. SC) and by assigning a status to each supplier (as shown in FIG. 5D). The user may also identify the relevant contracts (shown in FIG. 5E) and the category stakeholders (shown in FIG. 5F). Once this Input Data is gathered, the user will review and confirm the Internal Category Landscape, as shown in FIG. 5G.

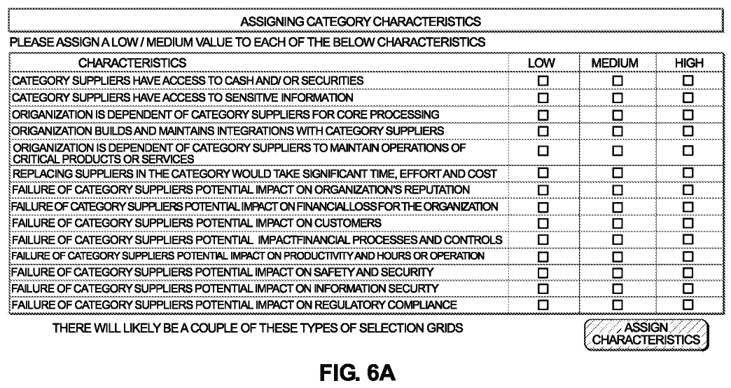

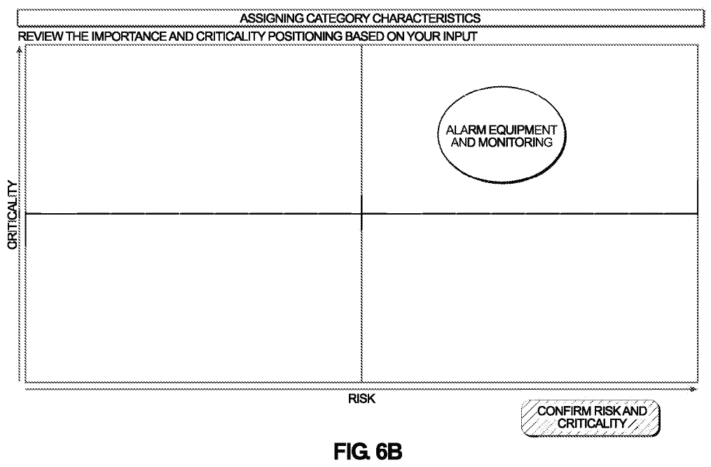

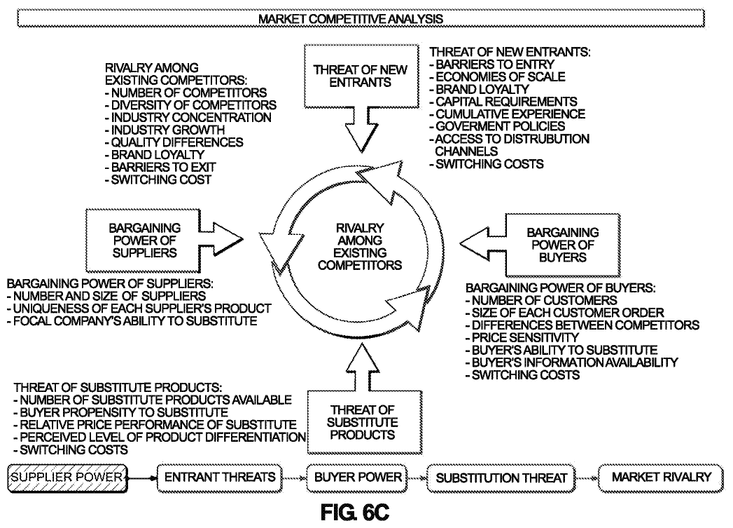

Referring now to FIGS. 6A-6C, there are shown demonstrative views of embodiments of the procurement category management system. Once the internal category landscape is defined, the category risks and criticality are to be identified. This can be done by identify the category risks, criticality and special considerations using one or more selection grids (as shown in FIG. 6A). Once this Input Data is gathered, it may be viewed on a Risk-Criticality matrix (as shown in FIG. 6B) or in association with the forces of a Porter Analysis (as shown in FIG. 6C) to assist in determining the user's strategic position.

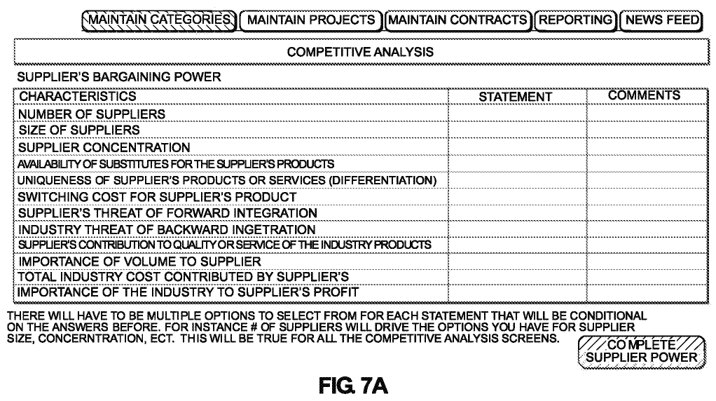

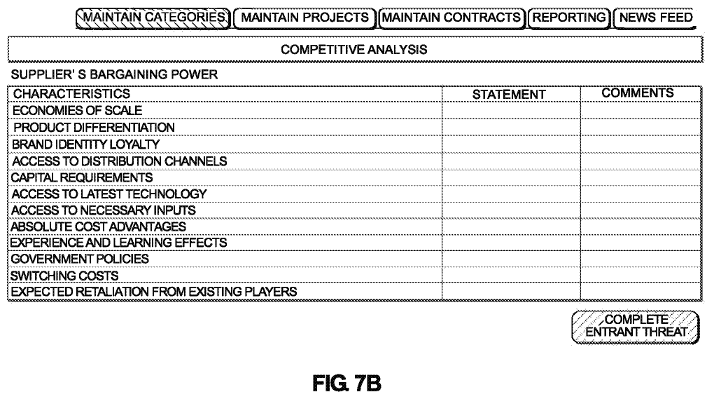

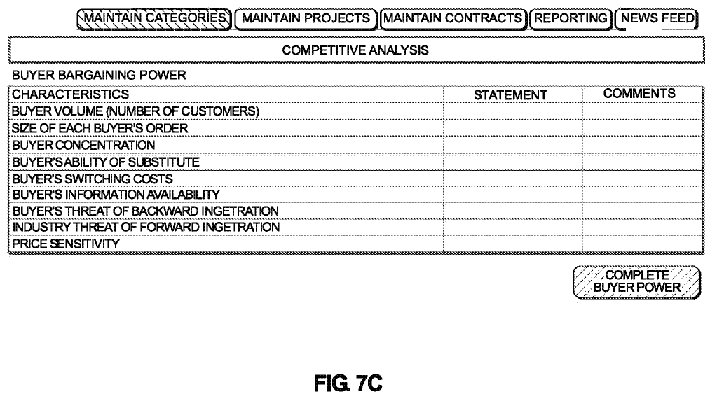

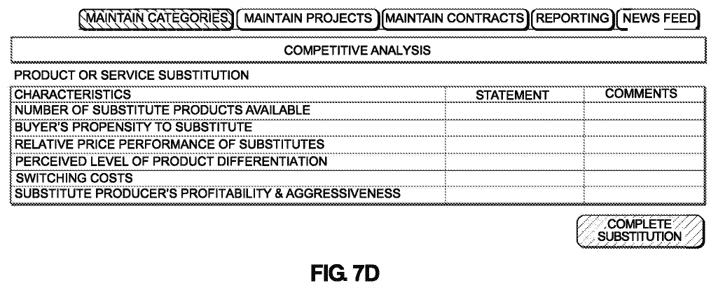

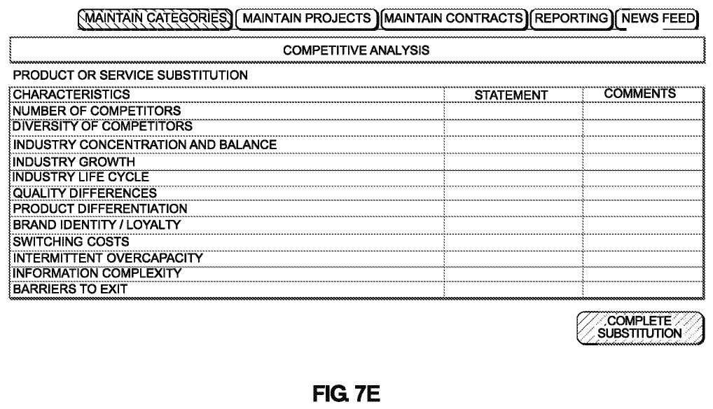

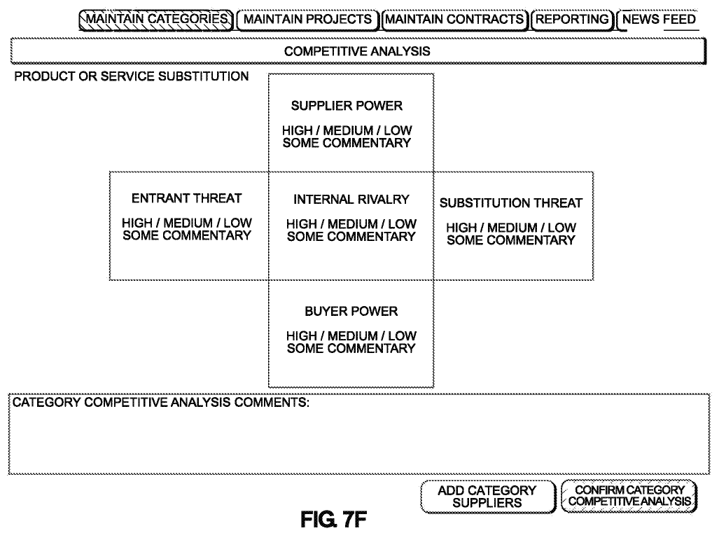

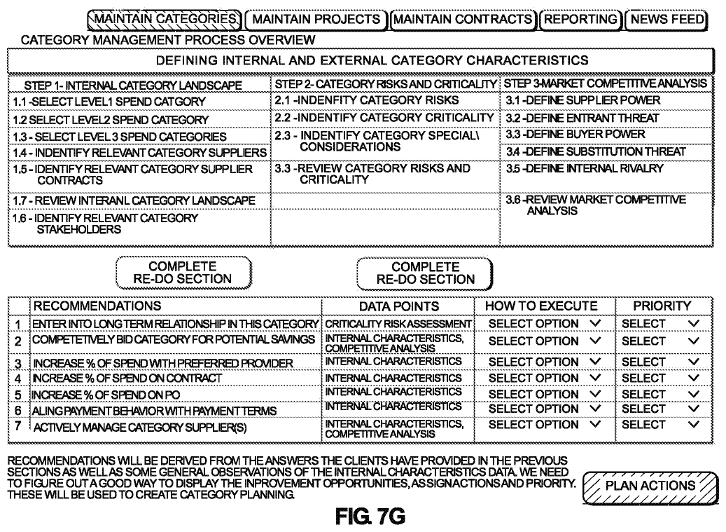

Referring now to FIGS. 7A-7F, there are shown demonstrative views of embodiments of the procurement category management system. The user will be able to provide input data to further refine the Porter Analysis. This can be done by providing information relevant to the Bargaining Power of the Suppliers (as shown in FIG. 7A), the Threat of New Entrants (as shown in FIG. 78), The Bargaining Power of the Buyers (as shown in FIG. 7C), the Threat of Substitutions (as shown in FIG. 7D) and the Internal Rivalry (as shown in FIG. 7E). This information can again be reproduced in a visual form, such as the chart shown in FIG. 7F. Once this information is confirmed, a number of recommendations will be generated.

Referring now to FIG. 8, there is shown a demonstrative view of an embodiment of the procurement category management system. These recommendations are generated as a result of the Input Data gathered by the prompts shown and described in FIGS. 5A-7F, as well as the Existing Data gathered automatically from Existing Sources. The user will be able to select execution options and priority levels at which the recommendation is to be accepted.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method, comprising:
establishing communication between at least one computer system having a computer-readable storage median, at least one processor, at least one input device and at least one output device;
registering, by the computer system, existing data from a data source;
registering, by the at least one input device, input data;
creating a database of categories, each category comprising a portion of the existing data and a portion of the input data;
translating the existing data and the input data into procurement data having at least one parameter indicative of criticality, at least one parameter indicative of risk and at least one parameter indicative of value;
analyzing the parameters of the criticality parameter, the risk parameter and the value parameter of each category to determine a category strategy.

2. The method of claim 1, wherein the database of categories comprises a plurality of sub-categories under each category.

3. The method of claim 1, wherein existing data is gathered by an artificial intelligence program.

4. The method of claim 1, wherein a machine learning program is utilized to define a plurality of categories within the database of categories.

5. The method of claim 1, wherein the category strategy for each category is determined using post-analyzation data.

6. The method of claim 1, further comprising:
defining a project list corresponding to each category strategy.

7. The method of claim 6, further comprising:
tracking and defining a status of each project of the project list.

8. The method of claim 7, further comprising:
determining an effectiveness value using a plurality of category metrics.

9. The method of claim 1, further comprising
monitoring existing data and input data to identify a plurality of changes;
analyzing the plurality of changes;
modifying the category strategy based on the plurality of changes.

10. A method, comprising:
establishing communication between at least one computer system having a computer-readable storage median, at least one processor, at least one input device and at least one output device;
registering, by the computer system, existing data from a data source;
registering, by the at least one input device, input data;
creating a database of categories, each category comprising a portion of the existing data and a portion of the input data;
translating the existing data and the input data into procurement data having at least one parameter indicative of criticality, at least one parameter indicative of risk and at least one parameter indicative of value;
analyzing the parameters of the criticality parameter, the risk parameter and the value parameter of each category to determine a category strategy;
defining a project list corresponding to each category;
tracking and defining a status of each project of the project list;
determining an effectiveness value using a plurality of category metrics;
monitoring existing data and input data to identify a plurality of changes;
analyzing the plurality of changes;
modifying the category strategy based on the plurality of changes.

11. A system, comprising:
at least one computer system having a processor;
the at least one computer comprising at least one input device and at least one output device;
a computer-readable storage medium storing a set of instructions that when executed will cause the processor to:
register existing data from a data source;
register input data gathered by the at least one input device;
create a database of categories, each category comprising a portion of the existing data and a portion of the input data;
translate the existing data and the input data into procurement data having at least one parameter indicative of criticality, at least one parameter indicative of risk and at least one parameter indicative of value;
analyze the parameters of the criticality parameter, the risk parameter and the value parameter of each category to determine a category strategy;
define a project list corresponding to each category;
track and define a status of each project of the project list;
determine an effectiveness value using a plurality of category metrics;
monitor existing data and input data to identify a plurality of changes;
analyzing the plurality of changes;
modify the category strategy based on the plurality of changes.
